(19) United States
(12) Patent Application Publication
(10) Pub. No.: US 2024/0258609 A1
(43) Pub. Date: Aug. 1, 2024

(54) COOLING PLATE ASSEMBLY FOR A BATTERY TRAY AND METHOD OF MANUFACTURING SAME

(71) Applicant: MAGNA INTERNATIONAL INC., Aurora (CA)

(72) Inventor: Christian HEILING, Weikersdorf am Steinfelde (AT)

(21) Appl. No.: 18/290,080

(22) PCT Filed: May 12, 2022
(86) PCT No.: PCT/CA2022/050754

§ 371 Date: Nov. 9, 2023

Related U.S. Application Data
(60) Provisional application No. 63/188,049, filed on May 13, 2021.

(51) Int. Cl. H01M 10/6556; H01M 10/613; H01M 10/6554

(52) U.S. Cl. CPC H01M 10/6556; H01M 10/613; H01M 10/6554

(57) ABSTRACT

A cooling plate assembly for cooling at least one battery module in a battery tray includes a first plate and a second plate disposed in stacked relationship with one another to collectively define a cooling channel extending therebetween. An adhesive is disposed between the first and second plate and extends along at least a portion of the cooling channel for structurally bonding the first and second plates to one another. At least one mechanical fixation is disposed adjacent the adhesive and extends between the first and second plates for maintaining a position of the first and second plates during a curing of the adhesive. A method of manufacturing the cooling plate assembly is also disclosed.

### CROSS-REFERENCE TO RELATED APPLICATION

This PCT International Patent application claims the benefit of and priority to U.S. Provisional Patent Application Ser. No. 63/188,049 filed on May 13, 2021, the entire disclosure of which is hereby incorporated by reference.

### BACKGROUND OF THE INVENTION

### 1. Field of the Invention

The present invention relates to a cooling plate assembly for cooling a battery module in a battery tray, and a method of manufacturing same.

### 2. Related Art

This section provides background information related to the present disclosure which is not necessarily prior art.

Automobiles are the subject of a continuing effort to reduce weight and increase fuel efficiency without detracting from performance. This desire to increase fuel efficiency is both economically and environmentally motivated and has advanced internal components in automobiles as evidenced by developments in batteries, particularly in electrified automobiles. Electrified automobiles include a range of technologies that rely on electric energy to propel an automobile. Some electrified automobiles still rely predominantly on fossil fuels and use electricity as a supportive energy to improve fuel efficiency. Other electrified automobiles rely predominantly or entirely on electricity for propulsion of the automobile. In either case, while electric energy is a more economically and environmentally favorable technology than relying completely on fossil fuels, batteries are heavy, expensive, and relatively fragile compared to neighboring mechanical components. As such, the packaging of batteries, particularly within an electrified vehicle, requires a number of design considerations including weight distribution, temperature regulation, and serviceability.

To meet the above minimum requirements, batteries have traditionally been packaged in protective housings that are constructed independent from a frame of the automobile. These traditional housings often include cooling structures to maintain a battery temperature within an optimum range during operation of the battery tray. One particular type of cooling structure is a cooling plate assembly which includes at least one cooling channel disposed between a top (first) plate and a bottom (second) plate that are connected to one another. The top plate and bottom plate are typically connected via a controlled atmosphere brazing (CAB), vacuum brazing, or roll bonding manufacturing process. However, these manufacturing processes are expensive, complicated, and are limited to only working with specific materials and under discrete manufacturing conditions.

Accordingly, there is a continuing desire to further develop and refine a cooling plate assembly that is not subject to the traditional drawbacks associated with the present methods of securing the first and second plates to one another and manufacturing the battery cooling assembly.

### SUMMARY OF THE INVENTION

According to one aspect of the disclosure, a cooling plate assembly for cooling at least one battery module in a battery tray includes a first plate and a second plate disposed in stacked relationship with one another and collectively defining a cooling channel extending therebetween. An adhesive is disposed between the first and second plates and extends along at least a portion of the cooling channel for structurally bonding the first and second plates to one another. At least one mechanical fixation is disposed adjacent the adhesive and mechanically fixates the first and second plates to one another for maintaining a position of the first and second plates during a curing of the adhesive.

In accordance with another aspect of the disclosure, a method of manufacturing a cooling plate assembly includes forming a first plate and a second plate, and forming a cooling channel in at least one of the first plate or the second plate. The method proceeds by applying an adhesive along at least a portion of the cooling channel, and then disposing the first plate and the second plate in stacked relationship with one another. Before curing the adhesive, the method includes disposing at least one mechanical fixation adjacent the adhesive to maintain a position of the first and second plates, followed by the curing the adhesive to structurally bond the first and second plates to one another.

The cooling plate assembly and method of manufacturing same which utilizes the adhesive to structurally bond the first and second plates to one another, in lieu of the controlled atmosphere brazing (CAB), vacuum brazing, or roll bonding prior art manufacturing processes, provides a less expensive, more simplified, dynamic, and easier to service solution for structurally securing the first and second plates together to manufacture the cooling plate assembly.

### BRIEF DESCRIPTION OF THE DRAWINGS

Other aspects and advantages of the present disclosure will be readily appreciated, as the same becomes better understood by reference to the following detailed description when considered in connection with the accompanying drawings wherein:

FIG. 1 is a perspective view of a battery tray illustrating a cooling plate assembly extending above and below at least one battery module and including at least one mechanical fixation disposed adjacent a cooling channel for mechanically fixating a first plate to a second plate;

FIG. 2 is a cross-sectional view of another arrangement of the battery tray illustrating the cooling plate assembly located between adjacent battery modules;

FIG. 3 is a perspective view of a first embodiment of the cooling plate assembly illustrating the at least one mechanical fixation comprised of a clinch and an adhesive extending continuously along opposing sides of the cooling channel;

FIG. 4 is a magnified top perspective view of a portion of FIG. 3 more clearly illustrating a top portion of the clinch;

FIG. 5 is a magnified bottom perspective view of a portion of FIG. 3 more clearly illustrating a bottom portion of the clinch;

FIG. 6 is a perspective view of a second embodiment of the cooling plate assembly illustrating the at least one mechanical fixation comprised of a resistance spot weld;

FIG. 7 is a magnified top perspective view of a portion of FIG. 6 more clearly illustrating a top portion of the resistance spot weld;

FIG. 8 is a magnified bottom perspective view of a portion of FIG. 6 more clearly illustrating a bottom portion of the resistance spot weld;

FIG. 9 is a perspective view of a third embodiment of the cooling plate assembly illustrating the at least one mechanical fixation comprised of a mechanical fastener;

FIG. 10A illustrates a method of manufacturing the cooling plate assembly beginning by forming a first plate and a second plate and a cooling channel defined by at least one of the first plate and the second plate;

FIG. 10B sequentially illustrates the method of manufacturing the cooling plate assembly in which a bead of adhesive is applied to one of the first or second plates along opposing edges of the cooling channel;

FIG. 10C sequentially illustrates the method of manufacturing the cooling plate assembly in which the first and second plates are disposed in stacked relationship and mechanically joined via at least one mechanical fixture disposed adjacent the cooling channel and the adhesive;

FIG. 10D sequentially illustrates the method of manufacturing the cooling plate assembly in which the stacked first and second plates are placed in an oven to cure the adhesive;

FIG. 11 is a perspective view of a robotic arm assembly for applying the adhesive to one of the first or second plates; and

FIG. 12 is a perspective view of one of the first or second plates and illustrating multiple beads of adhesive disposed in parallel relationship with one another adjacent the cooling channel.

### DESCRIPTION OF THE ENABLING EMBODIMENTS

Example embodiments will now be described more fully with reference to the accompanying drawings. In general, the subject embodiments are directed to a cooling plate assembly for cooling at least one battery module in a battery pack, and a method of manufacturing and assembling the cooling plate assembly. The cooling plate assembly as described herein may be incorporated into a battery housing for use with an electrified or semi-electrified automobile, such as a car, pick-up truck, SUV a semi-truck or other automobiles. However, the example embodiments are only provided so that this disclosure will be thorough, and will fully convey the scope to those who are skilled in the art. Numerous specific details are set forth such as examples of specific components, devices, and methods, to provide a thorough understanding of the embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

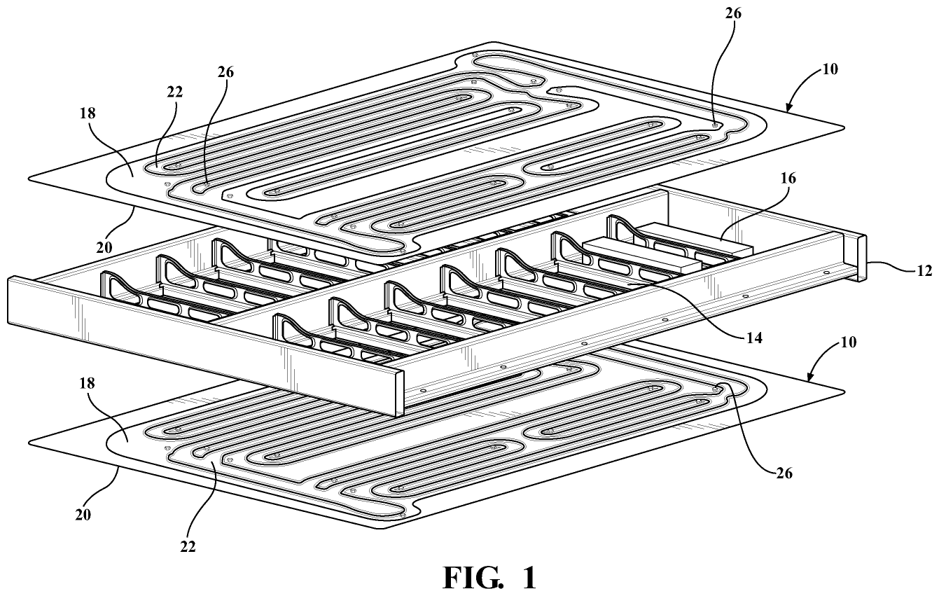

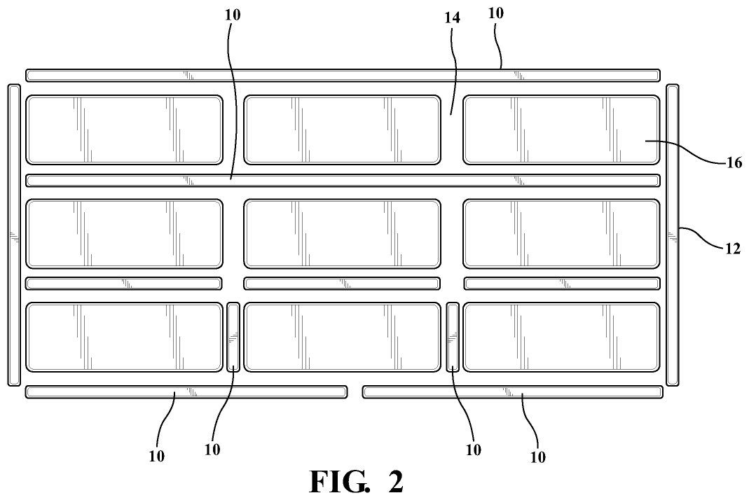

Referring initially to FIGS. 1 and 2, a cooling plate assembly 10 in accordance with the subject disclosure is intended for use with a battery tray 12 defining a plurality of pockets 14 for locating at least one battery module 16. The cooling plate assembly 10 extends along the battery tray 12 and is disposed adjacent the at least one battery module 16 for cooling the at least battery module 16 during an operation of the battery tray 10 in the electrified or semi-electrified automobile. As illustrated in FIGS. 1 and 2, the battery tray assembly 10 can extend along a top portion of the battery tray 10 in overlaying relationship with the at least one battery module 16, along a bottom portion of the battery tray 10 and underneath the at least one battery module 16, or along both the top and bottom portions of the battery tray 10 such that the at least one battery module 16 is disposed in sandwiched relationship between a top and bottom cooling plate assembly 10. Additionally, as illustrated in FIG. 2, the cooling plate assembly 10 could also be located between adjacent battery modules 16 within the battery tray 10.

In any arrangement, and as best illustrated in FIGS. 1, 3, 6, 9 and 10B-C, the cooling plate assembly 10 includes a first plate 18 and a second plate 20 disposed in stacked relationship with one another to collectively define a cooling channel 22 extending therebetween. The cooling channel 22 may be formed on one or both of the first plate 18 and the second plate 20 via a process such as stamping before the first and second plates 18, 20 are stacked on one another. More specifically, the entire cooling channel 22 could be defined by one of the first or second plates 18, 20, or a portion (e.g., half) of the cooling channel 22 could be defined by the first plate 18 and the remaining portion (e.g., other half) of the cooling channel 22 could by defined by the second plate 20 such that when the first and second plates 18, 20 are stacked together, the aligned portions of the cooling channels collectively define the cooling channel 22 extending between the plates 18, 20. The cooling channel 22 may be configured into any type of shape (e.g., serpentine, parallel lines, channels with expanded cooling pockets, etc.). In any of the aforementioned arrangements, a coolant is cycled through the cooling channel 22 during operation of the battery tray 12 for cooling the at least one battery module 16.

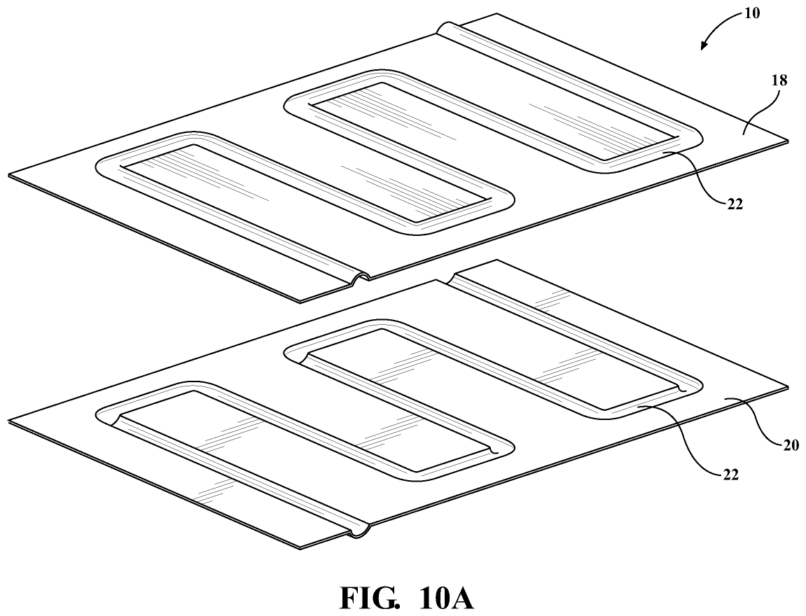

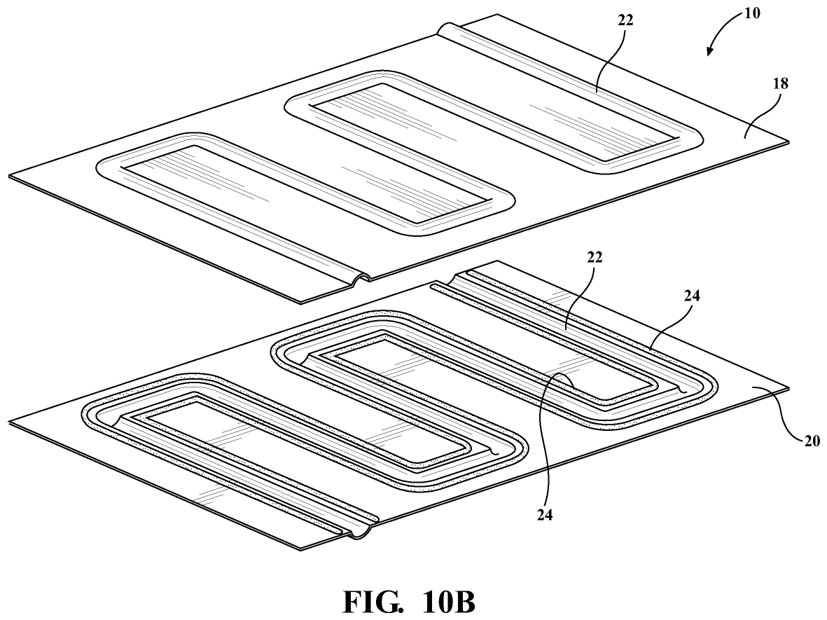

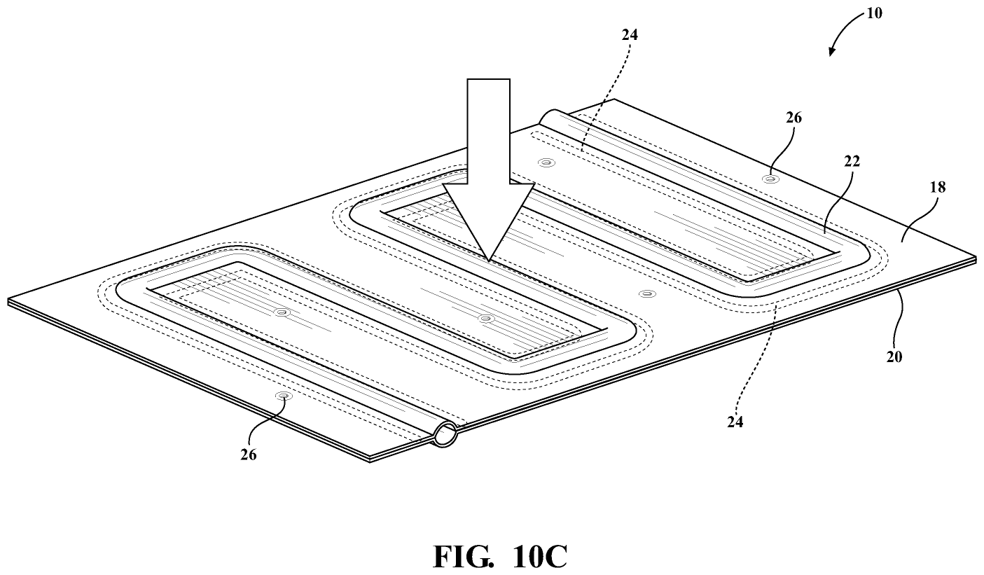

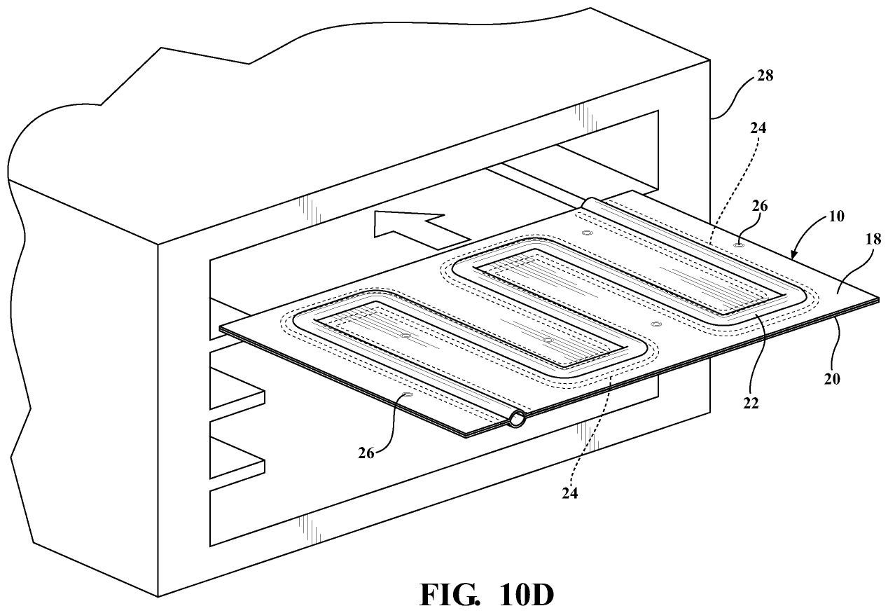

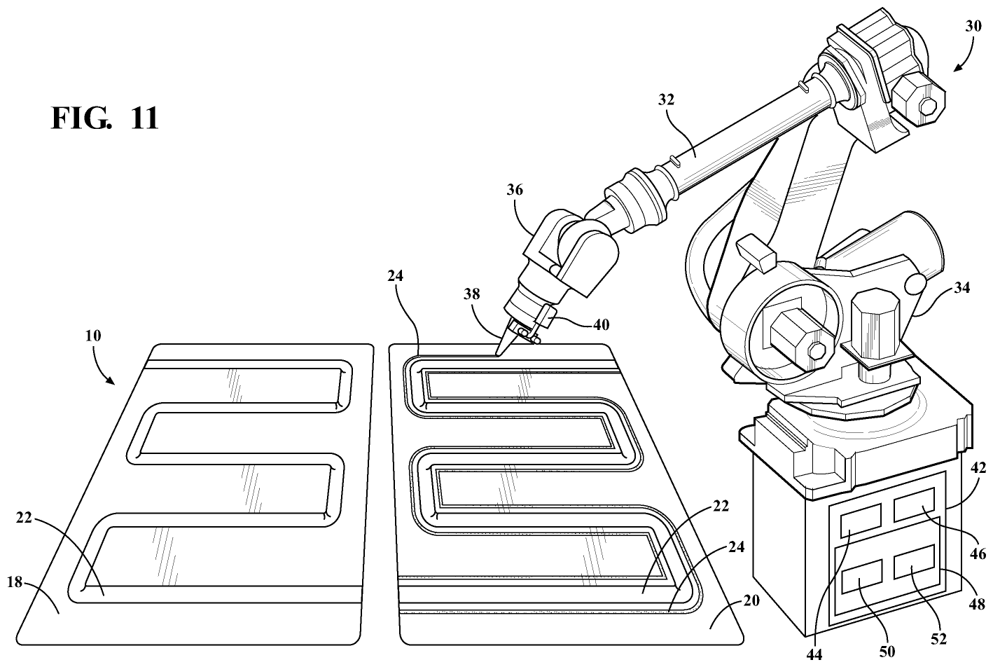

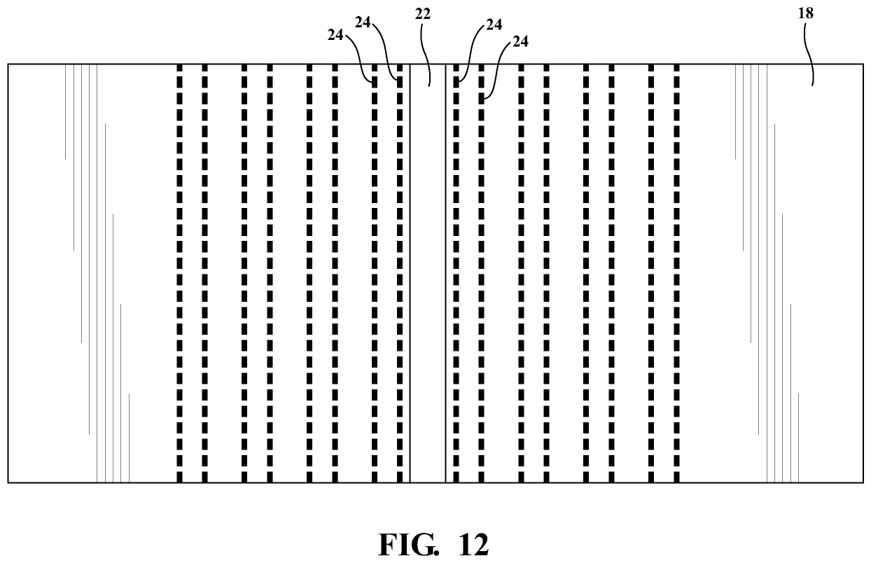

As best illustrated in FIGS. 10B and 11, before the first and second plates 18, 20 are disposed in stacked relationship with one another, an adhesive 24 is applied to at least one of the first and second plates 18, 20 and extends along and adjacent at least a portion of the cooling channel 22. In a preferred arrangement, the adhesive 24 extends continuously along the cooling channel 22, and even more preferably along both sides of the cooling channel 22. The adhesive 24 can be comprised of an epoxy resin, or of an epoxy base with an amine reactant. However, other compositions of the adhesive 24 can be utilized without departing from the scope of the subject disclosure. In an embodiment, the adhesive 24 can be applied at a temperature between 5 and 45 degrees Celsius.

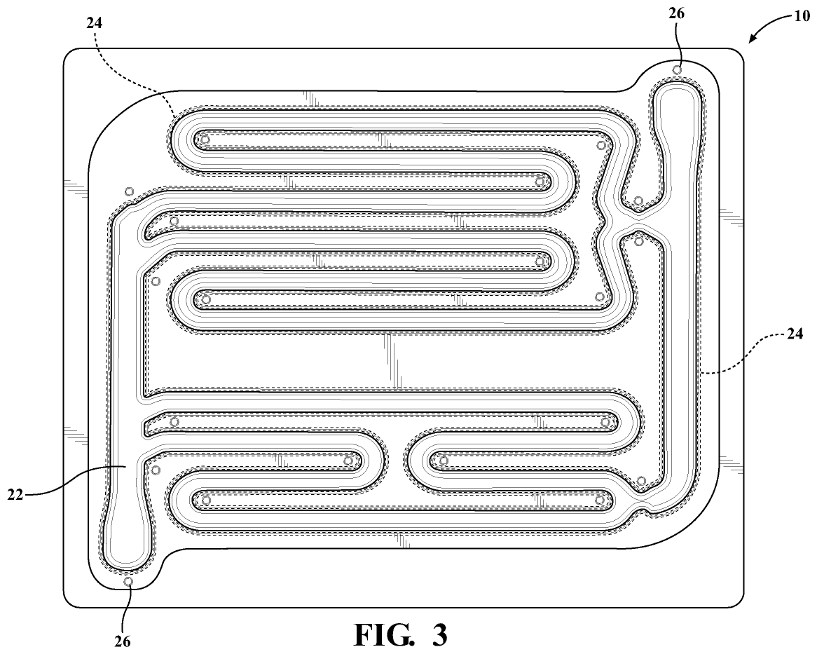

Next, and as best illustrated in FIGS. 10C, the first and second plates 18, 20 are brought or stacked together such that the adhesive 22 contacts both the first and second plates 18, 20 for adhesively securing the first and second plates 18, 20 to one another, and also sealing the cooling channel 22, especially when the adhesive 22 extends along both sides of the cooling channel 22. In order to maintain relative spacing, gaps and orientation of the first and second plates 18, 20 during a curing of the adhesive 24, at least one mechanical fixation 26 is disposed or placed adjacent the adhesive 24 and the cooling channel 22 and extends between the first and second plates 18, 20 for mechanically securing or fixating the first and second plates 18, 20 to one another. As further illustrated in FIGS. 3, 6 and 9, the at least one mechanical fixation 24 preferably includes a plurality of mechanical fixations 26 disposed adjacent the adhesive 24 and serially placed along the cooling channel 22 in spaced relationship with one another, each extending between the first and second plates 18, 20.

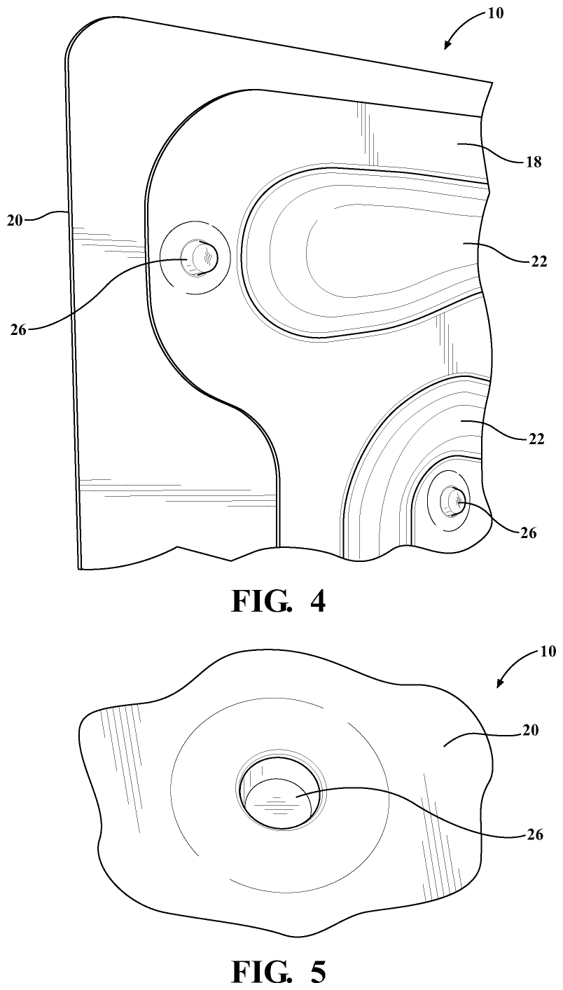

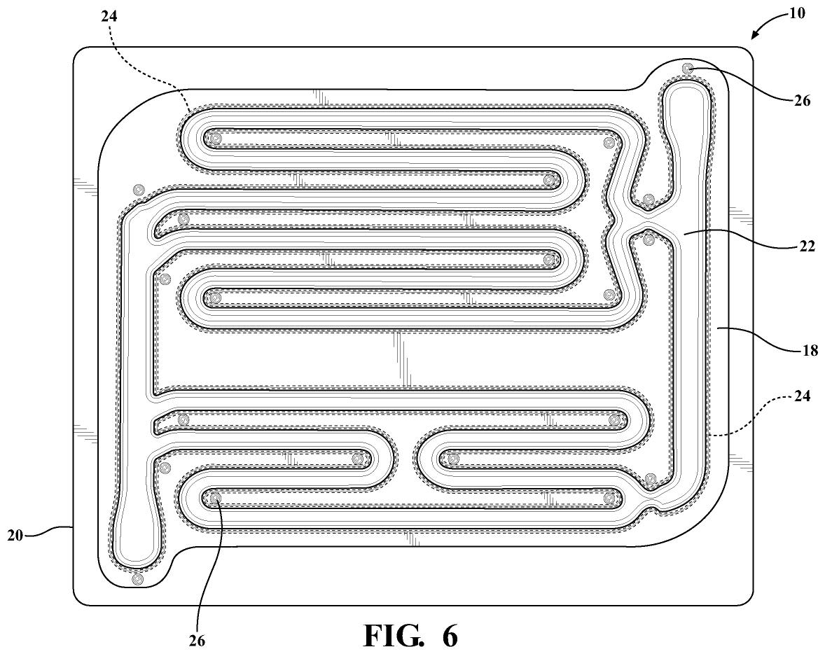

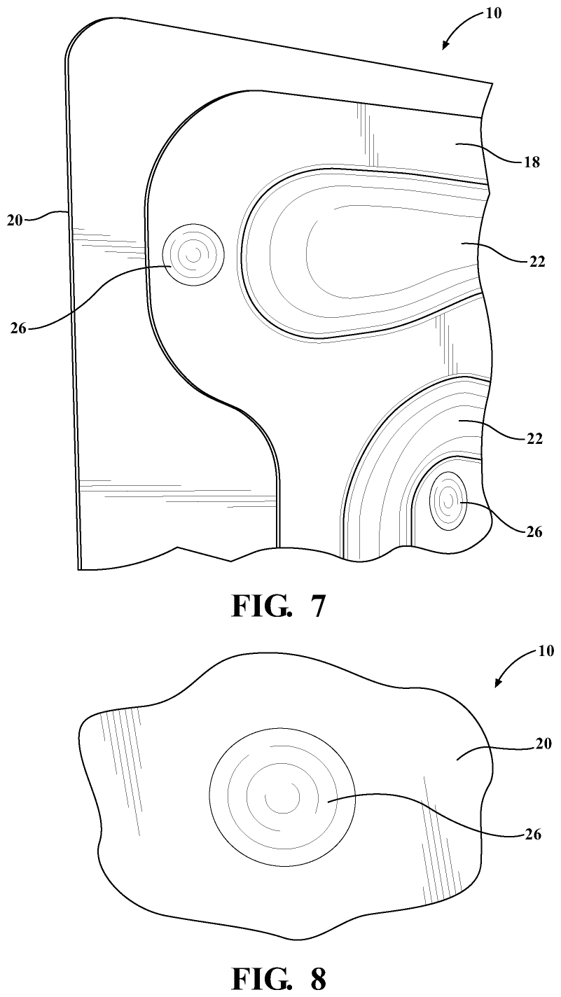

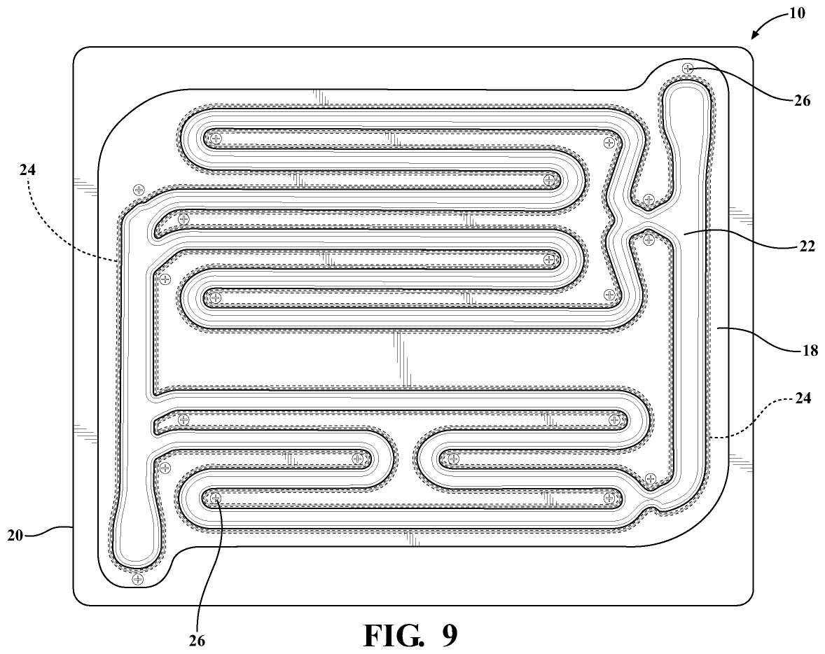

As illustrated in FIGS. 3-5, in a first embodiment, the at least one mechanical fixation 26 is comprised of a clinch. The clinching operation to mechanically fix the first and second plates 18, 20 can be performed via a massive stamping tool (with a plurality of clinches created in one step) or with a robot having machine mounted tongs. In either process, the requisite tools are standard parts and thus reduces the investment, processing and maintenance costs relative to the prior art methods of securing the first and second plates 18, 20 to one another. Alternatively, as illustrated in FIGS. 6-8, in an alternative embodiment the mechanical fixation 26 is comprised of a resistance spot weld (RSW). Further, in yet another alternatively embodiment, as illustrated in FIG. 9, the mechanical fixation 26 is comprised of a mechanical fastener, such as a bolt, screw, rivet or the like. Other means of a mechanical fixation 26 can be used without departing from the scope of the subject disclosure.

Once the at least one mechanical fixation 26 is disposed adjacent the adhesive 24 and the cooling channel 22, the adhesive 24 is cured to complete a structural bonding of the first and second plates 18, 20 to one another and complete manufacturing of the cooling plate assembly 10. The step of curing the adhesive 24 may include allowing the adhesive 24 to cure in ambient temperatures or may include placing the cooling plate assembly 10 into an oven or furnace 28, such as shown in FIG. 10D, to provide a shorter curing time and improved mechanical properties for the cured adhesive 24. In either process of curing the adhesive 24 via ambient or furnace conditions, the resultant cooling plate assembly 10 includes the adhesive 24 placed between the first and second plates 18, 20 and adjacent the cooling channel 22 for structurally bonding the first and second plates 18, 20 to one another. The at least one mechanical fixation 26 is utilized to avoid movements and gaps between the bonded parts until the adhesive 24 has cured to complete manufacturing of the cooling plate assembly 10. The use of the adhesive 24 to structurally bond the first and second plates 18, 20 to one another, in lieu of the controlled atmosphere brazing (CAB), vacuum brazing, or roll bonding prior art manufacturing processes, provides a less expensive, more simplified, dynamic, and easier to service solution for structurally securing the first and second plates 18, 20 together.

A method of manufacturing the cooling plate assembly 10 will now be described in more detail. Before adhesive 24 is applied to one of the first and second plates 18, 20, the method preferably begins by preparing (e.g., degreasing) the first plate 18 and the second plate 20 to insure the plates 18, 20 are free of greases and oils, and all oxide layers are removed. As illustrated in FIG. 10B, the method then proceeds by applying the adhesive 24 to at least one of the first plate 18 or the second plate 20 adjacent and along at least a portion of the cooling channel 22, as described above.

FIG. 11 illustrates a preferred method of applying the adhesive 24 via a robotic arm assembly 30. As illustrated therein, the adhesive 24 may be applied via the robotic arm assembly 30 to opposite sides of the cooling channel 22 such that the cooling channel 22 is entirely located between two outlining beads of adhesive 24 for sealing the cooling channel 22 from an environment of the cooling plate assembly 10. The robotic arm assembly 30 may include a robotic arm 32 that extends from a base 34 to a hand 36 having a nozzle 38 for dispensing the adhesive 24. A sensor 40 may measure the amount (e.g., bead cross-sectional volume) and location of the adhesive 24 dispensed from the nozzle 38. In some embodiments, the sensor 40 may be located on the hand 36, and can include an inline sensor, a laser sensor, a camera sensor, or combinations thereof.

As illustrated in FIG. 11, the robotic arm assembly 30 applies or places the adhesive 24 in beads that extend parallel or along both sides of the cooling channel 22 (i.e., the beads of adhesive 24 follow the pattern of the cooling channel 22). The robotic arm assembly 30 may include a control module 42 that includes a controller 44 having a processor 46 and a memory 48. The memory 48 may comprise a single disk or a plurality of disks (e.g., hard drives), and includes a storage management module that manages one or more partitions within the memory 48. In some embodiments, memory 48 may include flash memory, semiconductor (solid state) memory or the like. The memory 48 may include Random Access Memory (RAM), a Read-Only Memory (ROM), or a combination thereof. The memory 48 may include instructions that, when executed by the processor 46, cause the processor 46 to, at least, perform the systems and methods described herein. The memory 48 may include settings 50 such as flow rates, cooling channel shapes, mechanical fastener spacing, or combinations thereof. A communications module 52 may communicate with the sensors, actuators, nozzles, and other components of the robotic arm assembly 30. The communication can be performed by wireless communication, wired communication, pneumatic communication, hydraulic communication, or combinations thereof.

After the adhesive 24 is applied to at least one of the first or second plates 18, 20 via the robotic arm assembly 30, as described previously the plates 18, 20 are brought or stacked together such that the adhesive 24 contacts and is located between both the first plate 18 and the second plate 20 and disposed adjacent the cooling channel 22 for ultimately structurally bonding the first and second plates 18, 20 together. After the first plate 18 and the second plate 20 are brought together and disposed in stacked relationship with one another, they are mechanically fixated via the at least one mechanical fixation 26 placed at, into or adjacent the adhesive 24 to maintain a position of the first and second plates 18, 20 during a curing process for the adhesive 24. For example, the first plate 18 and the second plate 20 may be mechanically joined with the at least one mechanical fixation 26 comprised of clinches, resistance spot welds, mechanical fasteners (e.g., bolts, rivets, screws, etc.), or a combination thereof. In an embodiment, the at least one mechanical fixation 26 may be accomplished by the robotic arm assembly 30 (e.g., via a fixation tool on the hand 36).

After the mechanical fixation of the first and second plates 18, 20, the method proceeds by curing the adhesive 24 in ambient conditions, in the furnace 28, or some combination thereof to complete manufacturing of the cooling plate assembly.

It should be appreciated that the foregoing description of the embodiments has been provided for purposes of illustration. In other words, the subject disclosure it is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varies in many ways. Such variations are not to be regarded as a departure from the disclosure, and all such modifications are intended to be included within the scope of disclosure.

1. A cooling plate assembly for cooling at least one battery module in a battery tray, the cooling plate assembly comprising:
a first plate and a second plate disposed in stacked relationship with one another and collectively defining a cooling channel extending therebetween;
an adhesive disposed between said first and second plate and extending along at least a portion of said cooling channel for structurally bonding said first and second plates to one another; and
at least one mechanical fixation disposed adjacent said adhesive and extending between said first and second plates for maintaining a position of said first and second plates during a curing of said adhesive.

2. The cooling plate assembly of claim 1, wherein said at least one mechanical fixation includes a plurality of mechanical fixations disposed in spaced relationship with one another.

3. The cooling plate assembly of claim 1, wherein said adhesive extends continuously along said cooling channel.

4. The cooling plate assembly of claim 3, wherein said adhesive extends continuously along both sides of said cooling channel.

5. The cooling plate assembly of claim 1, wherein said at least one mechanical fixation is comprised of a clinch.

6. The cooling plate assembly of claim 1, wherein said at least one mechanical fixation is comprised of a resistance spot weld.

7. The cooling plate assembly of claim 1, wherein said at least one mechanical fixation is comprised of a mechanical fastener.

8. A battery tray comprising:
at least one battery module;
a cooling plate assembly disposed adjacent said at least one battery module for cooling said at least one battery module during operation of the battery tray;
said cooling plate assembly including:
a first plate and a second plate disposed in stacked relationship with one another and collectively defining a cooling channel extending therebetween;
an adhesive disposed between said first and second plate and extending along at least a portion of said cooling channel for structurally bonding said first and second plates to one another; and
at least one mechanical fixation disposed adjacent said adhesive and extending between said first and second plates for maintaining a position of said first and second plates during a curing of said adhesive.

9. A method of manufacturing a cooling plate assembly for cooling at least one battery module in a battery tray, the method comprising:
forming a first plate and a second plate;
forming a cooling channel in at least one of the first plate or the second plate;
applying an adhesive along at least a portion of the cooling channel;
disposing the first plate and the second plate in stacked relationship with one another;
disposing at least one mechanical fixation adjacent the adhesive to maintain a position of the first and second plates; and
curing the adhesive to structurally bond the first and second plates to one another.

10. The method of claim 9, wherein said step of disposing said at least one mechanical fixation includes disposing a plurality of mechanical fixations in spaced relationship with one another.

11. The method of claim 9, wherein said step of applying the adhesive includes applying the adhesive continuously along the cooling channel.

12. The method of claim 9, wherein said step of applying the adhesive includes applying the adhesive continuously along both sides of the cooling channel.

13. The method of claim 9, wherein the at least one mechanical fixation is comprised of a clinch.

14. The method of claim 9, wherein the at least one mechanical fixation is comprised of a resistance spot weld.

15. The method of claim 9, wherein the at least one mechanical fixation is comprised of a mechanical fastener.

16. The battery tray as set forth in claim 8, wherein said at least one mechanical fixation includes a plurality of mechanical fixations disposed in spaced relationship with one another.

17. The battery tray as set forth in claim 8, wherein said adhesive extends continuously along said cooling channel.

18. The battery tray as set forth in claim 8, wherein said at least one mechanical fixation is comprised of a clinch.

19. The battery tray as set forth in claim 8, wherein said at least one mechanical fixation is comprised of a resistance spot weld.

20. The battery tray as set forth in claim 8, wherein said at least one mechanical fixation is comprised of a mechanical fastener.
